(19) United States
(12) Patent Application Publication
(10) Pub. No.: US 2010/0313821 A1
(43) Pub. Date: Dec. 16, 2010

(54) BIOSAFETY LEVEL (BSL)-3 LIFE SUPPORT CELL FOR STUDYING LIVE ANIMALS

(75) Inventors: Sanjay K. Jain, Baltimore, MD (US); Stephanie L. Davis, Baltimore, MD (US); Peter Um, Houston, TX (US); Nick Be, Baltimore, MD (US)

Correspondence Address: VENABLE LLP, P.O. BOX 34385, WASHINGTON, DC, 20043-9998, US

(73) Assignee: The Johns Hopkins University, Baltimore, MD (US)

(21) Appl. No.: 12/816,941

(22) Filed: Jun. 16, 2010

Related U.S. Application Data
(60) Provisional application No. 61/187,461, filed on Jun. 16, 2009.

(51) Int. Cl. A01K 1/03

(52) U.S. Cl. 119/419

(57) ABSTRACT

A biological safety system includes a life-support cell, a supply system fluidly connected to the life-support cell, and an exhaust system fluidly connected to the life-support cell. The life-support cell is structured to contain a laboratory animal infected with microorganism of a type that requires bio-safety level 3 (BSL-3) isolation, is transparent to at least one form of radiation to permit observation of the laboratory animal while in use, and the biological safety system contains the microorganism that infect the laboratory animal within the life-support cell while permitting the observations of the laboratory animal from a bio-safety level 2 (BSL-2) environment without the microorganism escaping from the life-support cell.

### CROSS-REFERENCE OF RELATED APPLICATION

This application claims priority to U.S. Provisional Application No. 61/187,461 filed Jun. 16, 2009, the entire contents of which are hereby incorporated by reference.

### BACKGROUND

1. Field of Invention

The current invention relates to life-support cells for studying live animals, and more particularly to life-support cells for studying live animals infected with bio-safety level 3 (BSL-3) pathogens.

2. Discussion of Related Art

Research and manipulation of certain infectious-disease pathogens that can be transmitted via aerosol require bio-safety level 3 (BSL-3) facilities. These facilities are expensive, require substantial training for the personnel involved and require the use of protective clothing and equipment. Moreover, these BSL-3 pathogens (or animals infected with BSL-3 pathogens) cannot be studied using modern technologies such as imaging scanners which are ordinarily housed in BSL-2 facilities in most institutions and research facilities. To overcome this issue, some institutions have spent millions of dollars to house such expensive equipment in a BSL-3 facility. Consequently, there remains a need for improved bio-safety systems for handling BSL-3 pathogens and animals infected with BSL-3 pathogens.

### SUMMARY

A biological safety system according to some embodiments of the current invention includes a life-support cell, a supply system fluidly connected to the life-support cell, and an exhaust system fluidly connected to the life-support cell. The life-support cell is structured to contain a laboratory animal infected with microorganism of a type that requires bio-safety level 3 (BSL-3) isolation, is transparent to at least one form of radiation to permit at least one of imaging or observation of the laboratory animal while in use, and the biological safety system contains the microorganism that infect the laboratory animal within the life-support cell while permitting the observations of the laboratory animal from a bio-safety level 2 (BSL-2) environment without the microorganism escaping from the life-support cell.

### BRIEF DESCRIPTION OF THE DRAWINGS

Further objectives and advantages will become apparent from a consideration of the description, drawings, and examples.

FIG. 1 is an illustration of a biological safety system according to an embodiment of the current invention.

FIG. 2 is an illustration of a portion of the biological safety system of FIG. 1.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification are incorporated by reference as if each had been individually incorporated.

We have developed a simple and low cost alternative to the above-noted problem of being unable to study BSL-3 pathogens (or animals infected with BSL-3 pathogens) using modern technologies such as imaging scanners which are ordinarily housed in BSL-2 facilities in most institutions and research facilities. An embodiment of the current invention is a device that provides life-support and anesthesia for live animals inside of a sealed, transparent and unbreakable cell. This device according to an embodiment of the current invention can allow the study of animals infected with BSL-3 pathogens in a BSL-2 facility, making available most standard equipment housed in BSL-2 facilities for the study of BSL-3 pathogens.

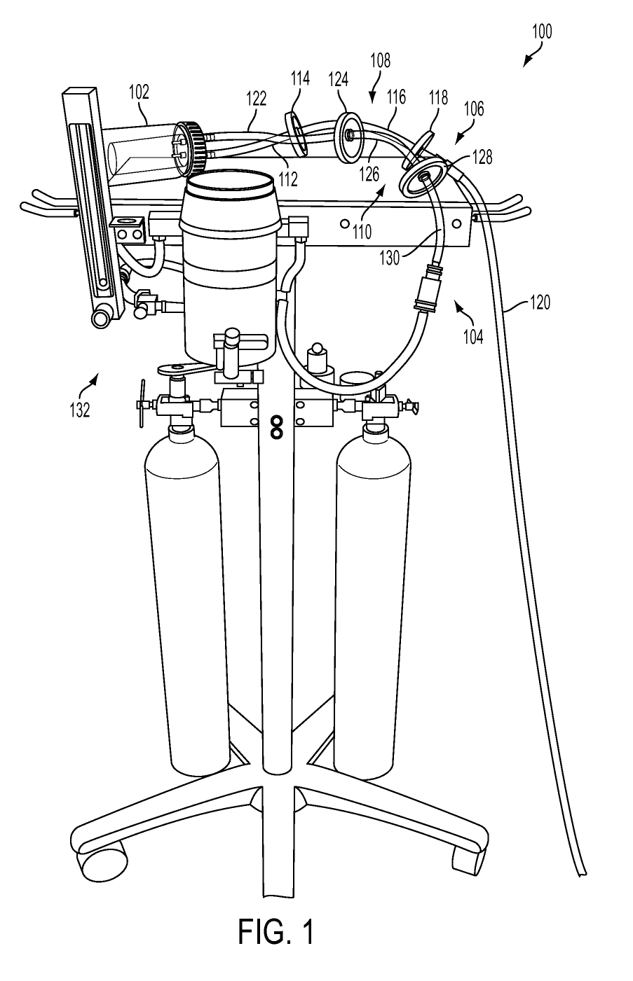

FIG. 1 is an illustration of a biological safety system 100 according to an embodiment of the current invention. The biological safety system 100 includes a life-support cell 102, a supply system 104 fluidly connected to the life-support cell 102, and an exhaust system 106 fluidly connected to the life-support cell 102. The life-support cell 102 is structured to contain a laboratory animal infected with microorganism (e.g., bacteria) of a type that requires bio-safety level 3 (BSL-3) isolation, is transparent to at least one form of radiation to permit observation of the laboratory animal while in use, and contains the microorganism that infect the laboratory animal within the life-support cell 102 while permitting the observations of the laboratory animal from a bio-safety level 2 (BSL-2) environment without the microorganism escaping from the life-support cell 102. The term “radiation” is intended to have a broad meaning to include all forms of radiation, including all forms of electromagnetic radiation and charged-particle radiation. For example, visible light, infrared light, x-rays, γ-rays and charged particles from radioactivity are all examples of forms of “radiation” within the general definition.

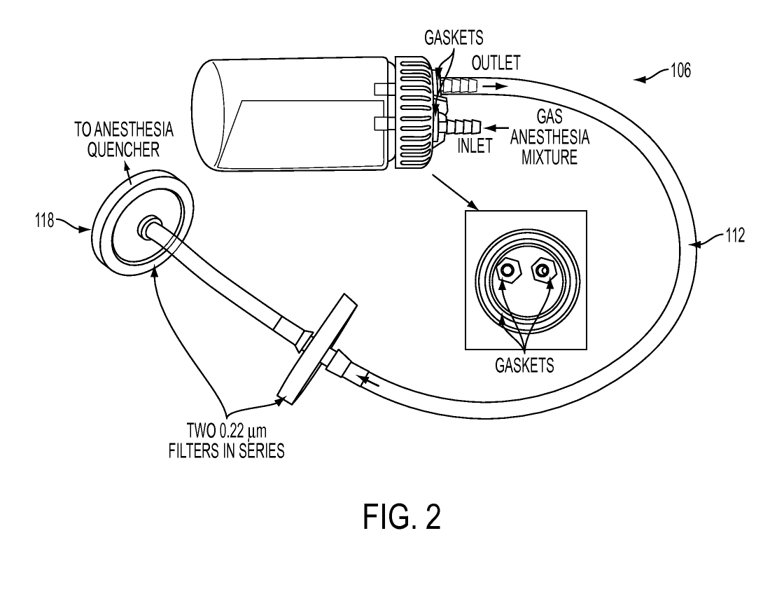

FIG. 2 is an enlarged view of the life-support cell 102 and a portion of the exhaust system 106 for the embodiment of FIG. 1. The exhaust system 106 includes an exhaust filter system 108 that prevents the microorganism from escaping the life-support cell through the exhaust system 106. The supply system 104 similarly includes a supply filter system 110 that prevents the microorganism from escaping the life-support cell 102 through the supply system 104. In the embodiment of FIG. 1, the exhaust system 106 includes tubing 112 providing a BSL-3 fluid connection of the life-support cell 102 to a first filter 114 of the exhaust filter system 108. The exhaust system 106 also includes tubing 116 providing a BSL-3 fluid connection between the first filter 114 and a second filter 118 of the exhaust filter system 108 to provide two filters in series. Additional tubing 120 provides further fluid connection of the exhaust system 106 to additional components of the exhaust system 106 and/or to external components, such as a quencher for the anesthetic. Although two filters in series have been found to work well for certain applications, other embodiments could use a single filter or more than two filters in series, depending on the particular application.

In the embodiment of FIG. 1, the supply system 104 includes tubing 122 providing a BSL-3 fluid connection of the life-support cell 102 to a first filter 124 of the supply filter system 110. The supply system 104 also includes tubing 126 providing a BSL-3 fluid connection between the first filter 124 and a second filter 128 of the supply filter system 110 to provide two filters in series. Additional tubing 130 provides further fluid connection of the supply system 104 to additional components of the supply system 104 and/or to external components. For example, the supply system can include an anesthesia and air (or oxygen) supply system 132 in some embodiments of the current invention. Although two filters in series have been found to work well for certain applications, other embodiments could use a single filter or more than two filters in series, depending on the particular application.

The filters 114, 118, 124, 128 have average pore sizes that are less than 0.5 μm and greater than 0.1 μm according to some embodiments of the current invention. For pores sizes greater than 0.5 μm, there is a risk of BSL-3 microorganisms such as bacteria being able to escape from the biological safety system 100. For pore sizes less than 0.1 μm, the filters may be prone to clogging making it difficult to obtain and accurately control flow of fluids through the supply system 104 and the exhaust system 106. In some embodiments, the filters 114, 118, 124, 128 have average pore sizes that are less than 0.3 μm and greater than 0.2 μm to provide better isolation of certain BSL-3 microorganism and to better facilitate and control the rate of fluid flow. In one embodiment, average pore sizes of about 0.22 μm for filters 114, 118, 124, 128 was found to work well. The term “about 0.22 μm” is intended to be consistent with the industry practice of providing 0.22 μm filters within the accepted amount of manufacturing precision and error. However for some applications where microorganisms of smaller size need to be contained, these filters with smaller pore sizes may be used.

In some embodiments of the current invention, life-support cell 102 is transparent to visible light to allow, for example, observation of respiration of the laboratory animal contained within the life-support cell 102. For example, the life-support cell 102 can include a plastic or glass tube portion in some embodiments. The life-support cell 102 can further include a plastic cap, for example, that can be attached to the plastic or glass tube by a threaded screw connection with a gasket to improve the tightness of the seal. (See inset to FIG. 2.) In addition, connectors to connect to the supply system 104 and exhaust system 106 can similarly be attached to the plastic cap with gaskets to ensure a tight seal. However, there are many ways in which connectors could be provided without departing from the scope of the current invention. For example, they could be integrally formed as a portion of the cap or attached in some other “air-tight” way. Furthermore, the broad concepts of the current invention are not limited only to the tube plus cap type of structure shown as an example in FIGS. 1 and 2. Other embodiments include tear-resistant bags. In that case, the tear-resistant bag could also be an inflatable bag. In some embodiments, the life-support cell 102 can be disposable, such as disposable inflatable bags and/or disposable capped tube structures. Furthermore, the size of the life-support cell 102 can be selected according to the particular application. For example, without limitation, the life-support cell 102 can be relatively small for use with laboratory mice, or substantially larger for piglets or other larger animals.

In some embodiments, the life-support cell 102 is substantially transparent to x-ray radiation to allow observation of the laboratory animal with a CT system, for example, in a BSL-2 environment. The life-support cell 102 can also be constructed from non-magnetic materials in some embodiments such that it can be placed in an MRI system in a BSL-2 environment. The materials, thicknesses etc of the life-support cell 102 can also be selected to allow observation with higher energy electromagnetic radiation, such as y-rays, and/or charged-particle radiation.

We built an air tight, unbreakable and transparent BSL-3 life-support cell as illustrated in FIGS. 1 and 2. Using a standard screw cap centrifuge tube, we provided an inlet and outlet for gases by drilling 2 holes in the screw cap. To maintain air tight containment, the cap for this BSL-3 container and the gas inlet and outlet have gaskets. The anesthetic mixture (in air or oxygen) is delivered into this sealed container via the inlet. The gases exiting this container through the outlet and entering through the inlet are filtered through two 0.22 μm filters in series. Finally, the anesthesia gases are quenched by using a commercially available anesthesia quencher. We used a commercially available portable anesthesia machine for delivering the anesthesia gases (isoflurane) in this example. The anesthesia quencher and 0.22 μm filters were replaced periodically. In addition, sensors for cardiac/respiratory gating and for oxygen saturation measurements may be attached to the animal if required for the experiment. This can involve placing subcutaneous electrodes in the animal once it is anesthetized and should cause only minimal discomfort to the animal.

All animals scanned for >20 min were monitored for body temperature using a simple thermometer taped to the imaging detector or using an infrared thermometer. Various other types of monitoring devices can also be used in conjunction with the biological safety system according to embodiments of the current invention. External warming of the animal can be provided when required. For example, a heat lamp that is external to the life-support cell 102 has been found to work well in some applications. For larger animals 1000-2000 ml container could be used for containment, for example. Consequently, even though the laboratory animal is confined within a small container that would normally be considered to be detrimental to adequate survival times to conduct the desired tests, the biological safety system according to embodiments of the current invention have been found to permit good survival times.

We believe that embodiments of the current invention can be useful to several research centers or other institutions involved with research with BSL-3 pathogens, for example. Different sized containers can allow its use for small and large animals. Specific examples of particular uses include, but are not limited to, conducting imaging studies (CT, MRI, PET, SPECT). We have imaged more than 250 TB-infected mice and rabbits using this device in the Johns Hopkins Small Animal imaging suite housed in a BSL-2 facility. Some animals were anesthetized for >4 hrs without complications. These studies have been used for understanding TB pathogenesis and also for pre-clinical evaluation of new and existing TB drugs and vaccines. It should be noted that the scope of this device can extend to all other BSL-3 pathogens and to other technologies generally restricted to BSL-2 facilities.

The embodiments illustrated and discussed in this specification are intended only to teach those skilled in the art the best way known to the inventors to make and use the invention. Figures are not drawn to scale. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A biological safety system, comprising:
a life-support cell;
a supply system fluidly connected to said life-support cell; and
an exhaust system fluidly connected to said life-support cell,
wherein said life-support cell is structured to contain a laboratory animal infected with microorganism of a type that requires bio-safety level 3 (BSL-3) isolation,
wherein said life-support cell is transparent to at least one form of radiation to permit at least one of imaging or observation of said laboratory animal while in use, and
wherein said biological safety system contains said microorganism that infects said laboratory animal within said life-support cell while permitting said observations of said laboratory animal from a bio-safety level 2 (BSL-2) environment without said microorganism escaping from said life-support cell.

2. A biological safety system according to claim 1, wherein said exhaust system comprises an exhaust filter system that prevents said microorganism from escaping said life-support cell through said exhaust system.

3. A biological safety system according to claim 2, wherein said exhaust filter system comprises two filters arranged in series.

4. A biological safety system according to claim 3, wherein said two filters of said exhaust filter system each have an average pore size that is less than 0.5 μm and greater than 0.1 μm.

5. A biological safety system according to claim 3, wherein said two filters of said exhaust filter system each have an average pore size that is less than 0.3 μm and greater than 0.2 μm.

6. A biological safety system according to claim 3, wherein said two filters of said exhaust filter system each an average pore size that is about 0.22 μm.

7. A biological safety system according to claim 1, wherein said supply system comprises a supply filter system that prevents said microorganism from escaping said life-support cell through said supply system.

8. A biological safety system according to claim 7, wherein said supply filter system comprises two filters arranged in series.

9. A biological safety system according to claim 8, wherein said two filters of said supply filter system each have an average pore size that is less than 0.5 μm and greater than 0.1 μm.

10. A biological safety system according to claim 8, wherein said two filters of said supply filter system each have an average pore size that is less than 0.3 μm and greater than 0.2 ρm.

11. A biological safety system according to claim 8, wherein said two filters of said supply filter system each have an average pore size that is about 0.22 μm.

12. A biological safety system according to claim 1, wherein said supply system comprises an anesthesia system and an air supply system.

13. A biological safety system according to claim 1, wherein said at least one form of radiation that said life-support cell is transparent to visible light to allow observation of respiration of said laboratory animal.

14. A biological safety system according to claim 1, wherein said at least one form of radiation that said life-support cell is transparent to is x-ray radiation to allow observation of said laboratory animal with a CT system in a BSL-2 environment.

15. A biological safety system according to claim 1, wherein said life-support cell is constructed from non-magnetic materials such that said life-support cell can be placed in an MRI system in a BSL-2 environment.

16. A biological safety system according to claim 1, wherein said life-support cell comprises one of a glass or plastic tube.

17. A biological safety system according to claim 1, wherein said life-support cell comprises a tear-resistant, inflatable bag.
